(19) United States
(12) Patent Application Publication
(10) Pub. No.: US 2025/0322995 A1
(43) Pub. Date: Oct. 16, 2025

(54) Energy Storage Assembly Having Energy Storage Modules

(71) Applicant: Systematic Power Manufacturing, LLC, Knoxville, TN (US)

(72) Inventors: D. Alexander Patsos, Canajoharie, NY (US); John E. Krohn, Troy, NY (US); Glenn T. Bertrand, Davenport, NY (US); Chad E. Hall, Walton, NY (US); Nathan R. Talbot, Gilbertsville, NY (US)

(73) Assignee: Systematic Power Manufacturing, LLC, Knoxville, TN (US)

(21) Appl. No.: 19/175,325

(22) Filed: Apr. 10, 2025

Related U.S. Application Data
(60) Provisional application No. 63/632,806, filed on Apr. 11, 2024.

(51) Int. Cl. H01G 11/12; H01G 11/18; H01G 11/78; H01M 10/42; H01M 10/48; H01M 10/613; H01M 10/63; H01M 10/643; H01M 10/6563; H01M 50/213; H01M 50/296; H01M 50/502; H01M 50/51

(52) U.S. Cl. CPC H01G 11/12; H01G 11/18; H01G 11/78; H01M 10/425; H01M 10/482; H01M 10/486; H01M 10/613; H01M 10/63; H01M 10/643; H01M 10/6563; H01M 50/213; H01M 50/296; H01M 50/502; H01M 50/51; H01M 2010/4278

(57) ABSTRACT

An energy storage assembly for storing electrical energy. The assembly comprises a plurality of cabinets, wherein each cabinet has an input terminal for receiving electrical energy, and a negative terminal for delivering electrical energy. Each cabinet also has a plurality of energy storage modules. The modules are stacked in vertical arrangement along the cabinets. The modules each comprise two or more rows of energy storage cells, with each row of energy storage cells having its own positive and negative terminals. The rows of energy storage cells within each module reside electrically in series. Additionally, the energy storage modules reside electrically in series between the positive and negative terminals of its respective cabinet. Additionally, each of the plurality of cabinets resides electrically in series. A chilled gas coolant passes along the rows of energy storage cells to cool the cells during operation of the energy storage assembly.

### CROSS REFERENCE TO RELATED APPLICATIONS

This application claims the benefit of U.S. Ser. No. 63/632,806 filed Apr. 11, 2024. That application is entitled “Cooling System For An Energy storage assembly” and is incorporated herein in its entirety by reference.

### STATEMENT REGARDING FEDERALLY SPONSORED RESEARCH OR DEVELOPMENT

Not applicable.

### BACKGROUND OF THE INVENTION

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

### FIELD OF THE INVENTION

The present invention relates to energy storage devices. More specifically, the present disclosure relates to an energy storage module wherein ultra-capacitors are housed in series. Additionally, the present disclosure relates to an energy storage module wherein rows of ultra-capacitor cells are spaced apart for cooling. Further, the present disclosure pertains to a cooling system for an energy storage assembly.

### Technology in the Field of the Invention

In conventional energy storage assemblies, a plurality of ultra-capacitor cells, batteries, or other energy storage devices are loosely held together within a housing. Co-owned U.S. Pat. No. 9,892,868 demonstrates a housing system for a plurality of ultra-capacitor cells which serve to securely store the energy storage devices for safe transport.

The '868 patent beneficially offered a physical arrangement for energy storage devices wherein a small array of capacitor cells could be placed into a housing, with the housing offering two electrodes. An energy storage assembly was formed that served as a portable source of energy that could power, for example, a vehicle.

Ultra-capacitors, also referred to as electric double-layer capacitors (EDLC), are a class of energy storage devices capable of storing large amounts of energy. Specifically, ultra-capacitors can store 10 to 100 times more energy per unit volume or mass than their electrolytic equivalents. They can also charge/discharge much faster than batteries. Ultra-capacitors are sometimes termed “super” because of the high surface area of their electrodes and the very small separation distance between the positive and negative charge.

It is desirable to take the concept of a small grouping of energy storage cells as taught in the '868 patent and scale up into a large array of ultra-capacitors to form energy storage devices offering far more power. A number of such energy storage devices may then be used as energy modules, with the energy storage modules being stacked together in series within a cabinet to form a larger energy storage assembly offering a much greater potential.

### BRIEF SUMMARY OF THE INVENTION

An energy storage assembly having a plurality of energy storage modules is provided herein. Each energy storage module has a plurality of energy storage cells arranged in rows. Preferably, each energy storage cell is an ultra-capacitor cell.

The energy storage assembly has a first electrical terminal and a second electrical terminal. Each terminal is configured to receive and then deliver electrical energy. Similarly, each energy storage module within the energy storage assembly has a positive terminal and a negative terminal.

In one arrangement, the rows of energy storage cells reside along a shared plane. Each energy storage module comprises at least 4 rows of energy storage cells, and more preferably 6 rows. In addition, each row of energy storage cells comprises at least 2 energy storage cells positioned end-to-end, and more preferably eight or more energy storage cells. In this way, for example, a 6×8 array is provided.

In another aspect, energy storage assembly for storing electrical energy is provided. The energy storage assembly first comprises a cabinet. Optionally, the cabinet has two opposing walls. The cabinet has a first terminal for receiving electrical energy, and a second terminal for delivering electrical energy. The cabinet may be in electrical communication with a power station or a so-called micro-grid.

The energy storage assembly also includes a plurality of energy storage modules. Preferably, each energy storage module is placed on a shelf or rack along the cabinet such that the energy storage modules are stacked one on top of the other in a vertical arrangement. Preferably, the plurality of energy storage modules comprises at least 4 energy storage modules stacked one on top of the other.

Each energy storage module comprises:
two or more rows of energy storage cells, with the energy storage cells being connected electrically in series, and wherein each row of energy storage cells has its own positive terminal and negative terminal;
a plurality of cooling tubes, wherein each cooling tube comprises a tubular body having an inlet end, an outlet end opposite the inlet end, and an inner diameter, with each cooling tube receiving a respective row of energy storage cells end-to-end; and
a plurality of spacers residing around or between selected energy storage cells within each cooling tube, wherein the spacers form an annular space between a row of energy storage cells and the corresponding cooling tube.

In the energy storage assembly, the rows of energy storage cells within each energy storage module reside electrically in series. The energy storage cells may comprise batteries, capacitors, or a combination thereof. Likewise, the energy storage modules reside electrically in series between the first electrical terminal (e.g., positive terminal) of the energy storage assembly and the second electrical terminal (e.g., negative terminal) of the energy storage assembly.

The energy storage assembly may further comprise a plurality of busbars. A first portion of the busbars connects the negative terminal of a first energy storage module with the positive terminal of an adjacent second energy storage module. A second portion of the busbars connects the negative terminal of a first row of energy storage cells to the positive terminal of an adjacent second row of energy storage cells.

In one aspect, to provide the electrical connections within the cabinet, the negative terminal of each row of energy cells is in electrical communication with a positive terminal of an adjacent row of energy cells such that the rows of capacitor cells are in series. Preferably, the energy cells are ultra-capacitor cells.

In one embodiment, the energy storage assembly further comprises:
at least one temperature sensor associated with each energy storage module;
a bypass switch associated with each row of energy storage cells; and
a module controller associated with each energy storage module, wherein each module controller is configured to (i) receive data related to voltage passing through each energy storage module, and (ii) receive data from the at least one temperature gauge.

Additionally, the energy storage assembly may further comprise a cabinet controller. The cabinet controller is configured to receive data from each of the module controllers and, in response, control the bypass switches associated with the energy storage modules. In this way, current through selected rows of energy storage cells may be turned off.

In one embodiment, a plenum is provided for the energy storage assembly. The plenum is configured to deliver a chilled gas coolant into the cooling tubes. The chilled gas coolant is forced into the inlet end of each of the respective cooling tubes under pressure such that the chilled gas coolant moves horizontally through the annular space of each cooling tube and then out of the outlet end. Preferably, this is part of a closed-loop cooling system.

In one aspect, a valve is associated with the inlet end of each row of the energy storage cells. In this instance, the cabinet controller is in electrical communication with each of the valves, and is configured to sends signals to adjust a position of the respective valves to control a degree of cooling across the energy storage cells.

A separate energy storage assembly for storing electrical energy is provided herein. The energy storage assembly is designed in accordance with the energy storage assembly described above in its various embodiments, except that in this instance the assembly has two or more cabinets. Each cabinet has its own positive terminal for receiving and delivering electrical energy, and its own negative terminal for receiving and delivering electrical energy.

In this arrangement, the energy storage assembly may further comprise a plurality of busbars. Each of a first portion of the busbars connects the negative terminal of a first energy storage module with the positive terminal of an adjacent second energy storage module. At the same time, each of a second portion of the busbars connects the negative terminal of a first row of energy storage cells to the positive terminal of an adjacent second row of energy storage cells.

Each of the plurality of energy storage modules resides on a rack, a shelf, or a rail within a cabinet. Preferably, each energy storage cell within the modules is a capacitor cell. The negative terminal of each row of capacitor cells is in electrical communication with a positive terminal of an adjacent row of capacitor cells such that the rows of capacitor cells are in series.

The rows of energy storage cells within each energy storage module and within each cabinet reside electrically in series. Similarly, the energy storage modules in each cabinet reside electrically in series between the positive terminal and the negative terminal of its respective cabinet. And finally, each of the plurality of cabinets resides electrically in series. Thus, the energy storage modules deliver electrical energy from end-to-end, from row-to-row, and then from shelf-to-shelf.

Preferably, the energy storage assembly comprises at least ten cabinets. Each cabinet holds at least 4 energy storage modules stacked in vertical arrangement. The energy storage modules within each cabinet are in series. The cabinets may be in electrical communication with a power station or a micro-grid.

In one aspect, the cabinet controllers will take all of the data from each module, and compare the data, or readings, to baseline settings for temperature and voltage. The data collected by cabinet controllers may be fed to a master controller that monitors the flow of energy through all cabinets within the assembly.

### DESCRIPTION OF THE DRAWINGS

So that the manner in which the presently disclosed subject matter can be better understood, certain illustrations, charts and/or flow charts are appended hereto. It is to be noted, however, that the drawings illustrate only selected embodiments of the inventions and are therefore not to be considered limiting of scope, for the inventions may admit to other equally effective embodiments and applications.

FIG. 1 is a perspective view of an energy storage device of the present invention, in a first embodiment. The energy storage device comprises an array of ultra-capacitors, forming a module.

FIG. 2 is an end view of the energy storage module of FIG. 1.

FIG. 3 is another perspective view of the energy storage module of FIG. 1, but wherein the components are shown in exploded-apart relation.

FIG. 4 is a perspective view of an energy storage assembly of the present invention, in one embodiment. The energy storage assembly comprises a plurality of energy storage modules, stacked vertically within a cabinet.

FIG. 5 is a layout of the controller of the energy storage module of FIGS. 1 through 3. The layout is a set of components placed on a printed circuit board.

FIG. 6 is a circuit diagram that shows a schematic of the electrical connections between multiple energy storage modules within a cabinet.

FIG. 7A is a side view of the energy storage assembly of FIG. 4. This is a somewhat schematic view designed to demonstrate the movement of cooling fluid through the individual energy storage modules. A closed-loop cooling system is shown.

FIG. 7B is a side view of a plenum as may be used to deliver cooled working fluid into the cooling tubes of a stack of energy storage modules.

FIG. 7C is a side view of the energy storage assembly of FIG. 4. This is a somewhat schematic view designed to demonstrate the movement of cooling fluid through the individual energy storage modules. An open-loop cooling system is shown in this alternate embodiment.

FIG. 8A is a perspective view of a plurality of energy storage devices, stacked in vertical arrangement, in an alternate embodiment. Each energy storage device comprises an array of ultra-capacitors, forming a module.

FIG. 8B is a side view of the stack of energy storage modules of FIG. 8A.

FIG. 9 is a perspective view of one of the modules of FIG. 8B. In this view, one of the cooling tubes has been removed.

FIG. 10A is a first side view of an end of the module of FIG. 9. An electrolyte capture reservoir is shown along a lower end of the module.

FIG. 10B is a second side view of the end of the module of FIG. 9. In this view, electrolyte has been captured in the reservoir of the energy storage module.

FIG. 11 is an enlarged end view of the stack of energy storage modules of FIG. 8.

### DETAILED DESCRIPTION OF SELECTED SPECIFIC EMBODIMENTS

In the following description, reference is made to the accompanying figures that form a part thereof, and in which is shown by way of illustration exemplary embodiments in which the present disclosures may be practiced.

Certain features characteristic of the embodiments of the present application are set forth in the appended claims. However, the embodiments themselves and further objectives and advantages thereof, will best be understood by reference to the following detailed description when read in conjunction with the accompanying drawings, wherein:

The present disclosure generally relates to assemblies of energy storage modules. The present disclosure further relates to a cooling system for an energy storage assembly having a plurality of energy storage devices placed in vertical arrangement.

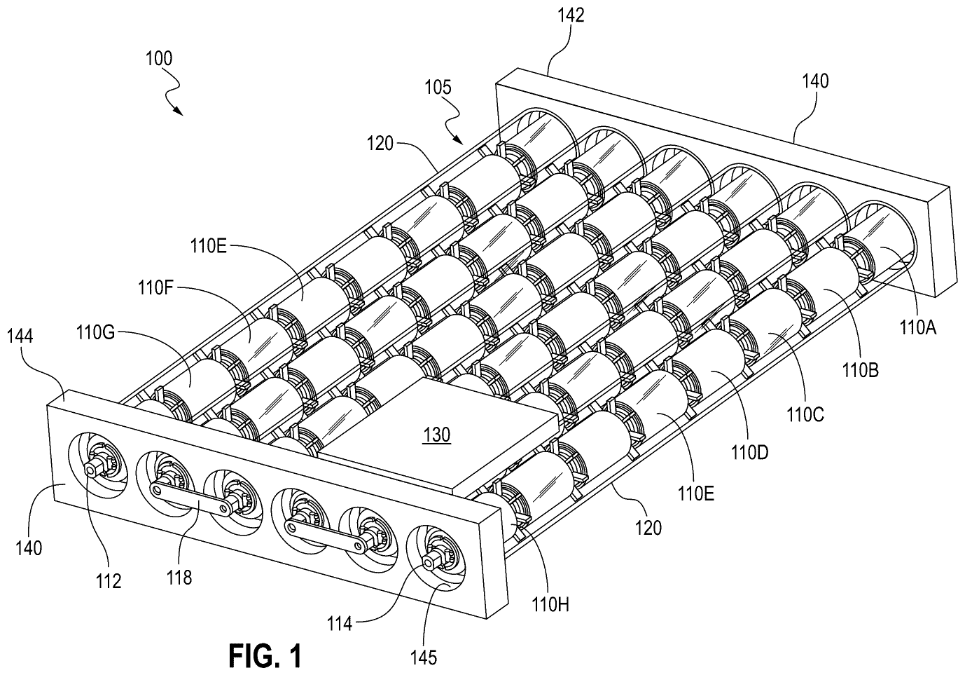

FIG. 1 is a perspective view of an energy storage module 100 of the present disclosure, in one embodiment. The energy storage module 100 includes rows 105 of ultra-capacitor cells 110, with each row 105 of ultra-capacitor cells 110 being housed in an elongated tubular body 120. The elongated tubular bodies 120 serve as cooling tubes and are referred to herein as such.

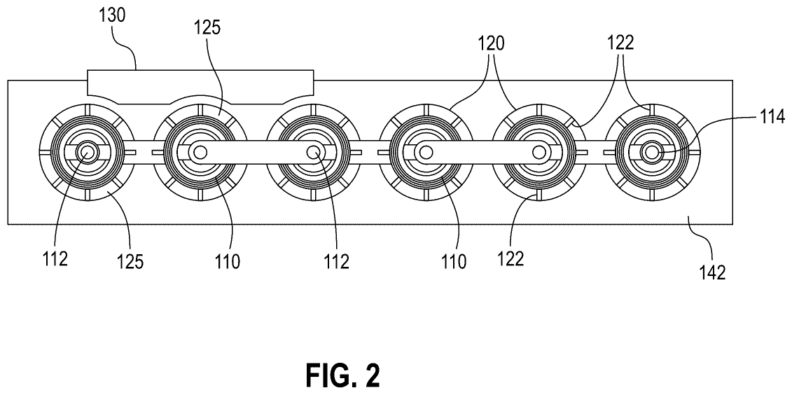

FIG. 2 is an end view of the energy storage module 100 of FIG. 1. Here, a first end plate (or bulkhead) 142 is shown with positive terminals 112 associated with each row 105 of ultra-capacitor cells 110.

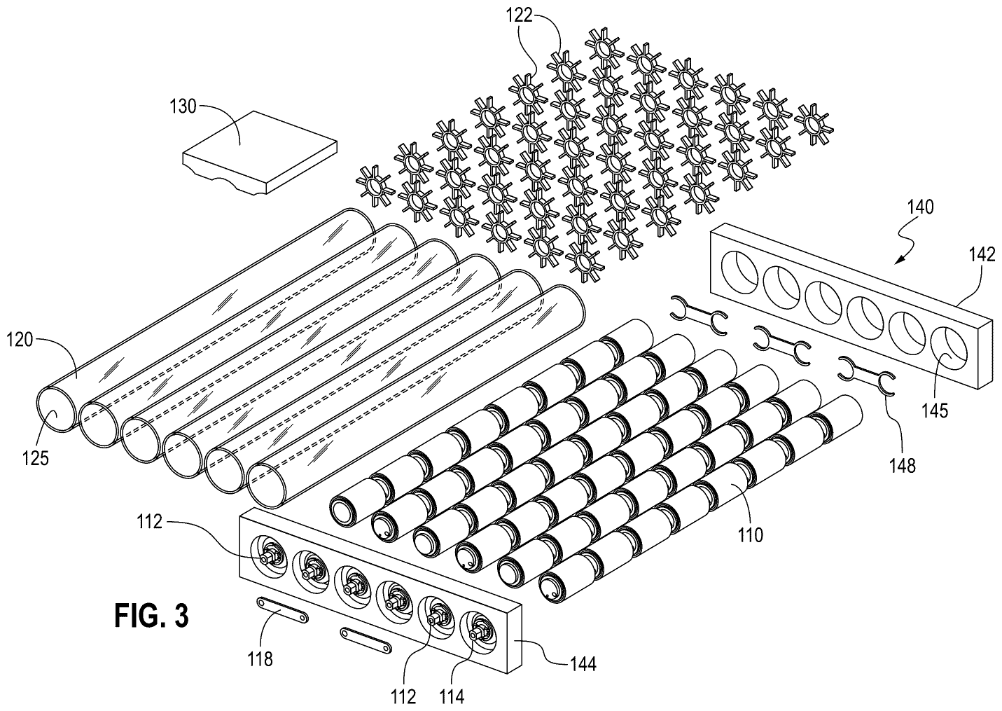

FIG. 3 is another perspective view of the energy storage module 100 of FIG. 1. In this view, the components of the energy storage module 100 are shown in exploded-apart relation.

The energy storage module 100 is designed to be one of a plurality of modules within an energy storage assembly, or cabinet. The energy storage module 100 will be discussed with reference to FIGS. 1, 2 and 3 together.

The energy storage module 100 first comprises a plurality of energy storage cells 110. The energy storage cells 110 are preferably ultra-capacitor cells. The ultra-capacitor cells 110 represent a row 105 of individual ultra-capacitor cells placed electrically in series, with the rows 105 being in side-by-side relation. In the illustrative arrangement of FIG. 1, six rows 105 of ultra-capacitor cells 110 are provided, with each row 105 having 8 individual ultra-capacitor cells 110. The individual ultra-capacitor cells 110 may be designated as cells 110A, 110B, 110C, . . . 110H. Thus, the ultra-capacitor cells 110 are configured in an array providing 6 rows of 8 ultra-capacitor cells 110, in series. This presents a 6×8 array with a total of 48 individual ultra-capacitor cells 110.

It is understood that the array of FIG. 1 is illustrative only, and that a larger or a smaller number of individual energy storage cells 110 may be employed in each row 105, and a greater or smaller number of rows 105 of energy storage cells 110 may be provided. It is also noted that some rows 105 may utilize Lithium-ion batteries or other electrical cells. However, ultra-capacitor cells 110 are preferred. Ultra-capacitors provide a unique balance between power density and energy density that makes ultra-capacitors a preferred choice for grid stabilization.

The energy storage cells 110 may embody a generally cylindrical geometry and are connectable end-to-end to form the rows 105. Each row 105 of energy storage cells 110 will have a positive terminal 112 and a negative terminal 114. Electrical energy is transmitted through the positive terminal 112, into energy storage cell 110A of each row 105, on to energy storage cell 110H of each row 105, and to negative terminal 114. In a preferred arrangement, all energy storage cells 110 are in series, meaning that the negative terminal 114 of one row 105 is in electrical connection with the positive terminal 112 of an adjacent row 105. In this arrangement, busbars 118 may be used to connect the adjacent negative 114 and positive 112 terminals.

Busbars 118 are seen in FIGS. 1 and 3. In these views, the busbars 118 are connected to terminals 112, 114 of adjoining rows 105 of energy storage cells 110. In this arrangement, one terminal, e.g., positive terminal 112, may comprise a threaded hole for receiving a connector for securing a busbar 118. Similarly, one terminal, e.g., negative terminal 114, may comprise a threaded stem for connecting to a nut for securing the respective busbar 118. As an alternative, the electrical connection may be made using a weld bond joining a terminal on each row 105 to one part of a busbar with a successive row 105 with a second part of the busbar 118. Such an arrangement is described in co-owned U.S. Pat. No. 9,892,868, which is incorporated herein in its entirety by reference.

For busbars 118, resistance is a function of length. Reducing the length of each busbar 118 by setting connected terminals near each other reduces overall system resistance. The operator may run power into either the positive side or the negative side of the module 100, so long as the busbars are arranged appropriately to feed current in series.

The rows 105 of ultra-capacitor cells 110 are supported at opposing ends by bulkheads 140. A first bulkhead (or end plate) 142 is provided at a first end of the rows 105 of ultra-capacitor cells 110, while a second bulkhead (or end plate) 144 is provided at a second end of the rows 105 of ultra-capacitor cells 110. Each bulkhead 140 includes a plurality of openings (or apertures) 145 designed to accommodate the positive 112 and negative 114 terminals of the rows 105 of ultra-capacitor cells 110.

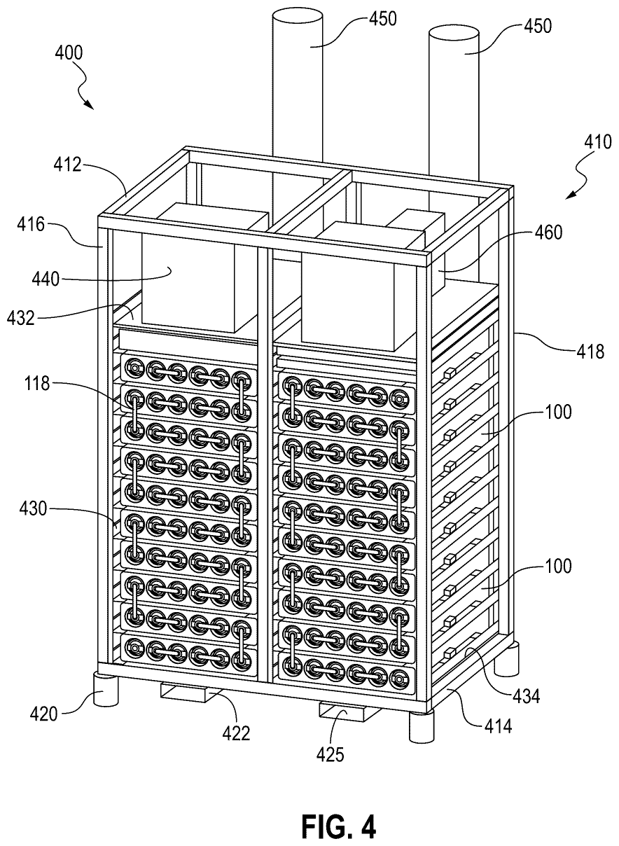

The bulkheads 140 may be fabricated from any composition capable of insulating electricity. Non-limiting examples include a polycarbonate material or a hardened butadiene rubber. Bulkheads 140 manufactured from a polymeric material can offer resistance to shocks and vibrations while preventing electrical shorting between the energy cells 110 and the larger support structure, e.g., cabinet 410 shown in FIG. 4. The design includes sufficient clearance and creepage distances through and over the plastic components to prevent electrical shorting.

Each terminal 112, 114 extends substantially through its corresponding bulkhead 140 via a corresponding aperture 145. The terminals 112, 114 are fabricated from an electrically conductive material so as to transfer electrical energy through a respective bus bar 118 and to an adjoining terminal 114, 112.

As noted, rows 105 of ultra-capacitor cells 110 are housed within cooling tubes 120. The cooling tubes 120 are preferably fabricated from a durable but light-weight, non-conductive material. Non-limiting examples include a translucent polycarbonate material. Each tube 120 may be, for example, between 12 and 36 (305 mm and 914 mm) inches in length, and have an outer diameter (or OD) of between 2 and 4 inches (51 mm and 102 mm). The cooling tubes 120 may be placed along racks (shown at 430 in FIG. 4) in horizontal orientation.

Spacers 122 are provided along the cooling tubes 120. The spacers 122 slide onto or otherwise encompass the outer diameters (or OD) of selected energy storage cells 110. The spacers 122 essentially centralize the individual energy storage cells 110 within the cooling tubes 120. In this way, an annular space 125 is formed between the energy storage cells 110 and an inner diameter (or ID) of the cooling tubes 120. As will be discussed later, the annular space 125 within the cooling tubes 120 receive a gas coolant during operation.

It is understood that it is not necessary for each individual energy storage cell 110 to receive its own spacer 122. Spacers 122 may be employed as needed to preserve the annular space 125. As an alternative, spacers 122 may be placed between selected energy storage cells 110 so long as electrical connection is maintained along the rows 105.

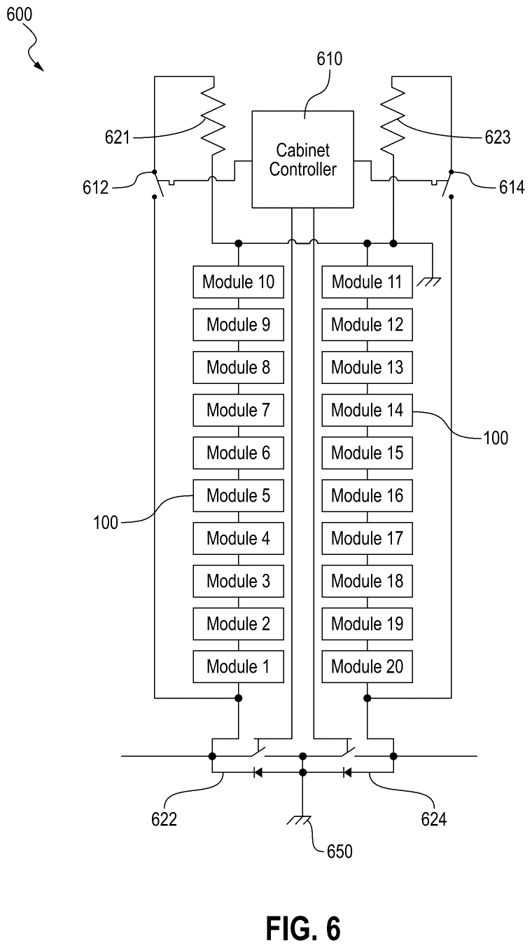

The energy storage module 100 also includes a module controller 130. The module controller 130 monitors the voltages and temperatures of the ultra-capacitor cells 110. Data related to voltage and temperature is sent from the module controllers 130 to a cabinet controller (described below at 610 in connection with FIG. 6).

The ESR and capacitance of every energy storage cell 110 can be calculated, and tracked over time. This allows the module controller 130 to predict when energy storage cells 110 will reach an end of life condition, and prevent cell failure, including venting. Further, the module controller 130 may send records of all collected data in a log server, which can be accessed and reviewed for root cause post-mortem analysis of failures, and to improve the lifetime predictions of cell performance.

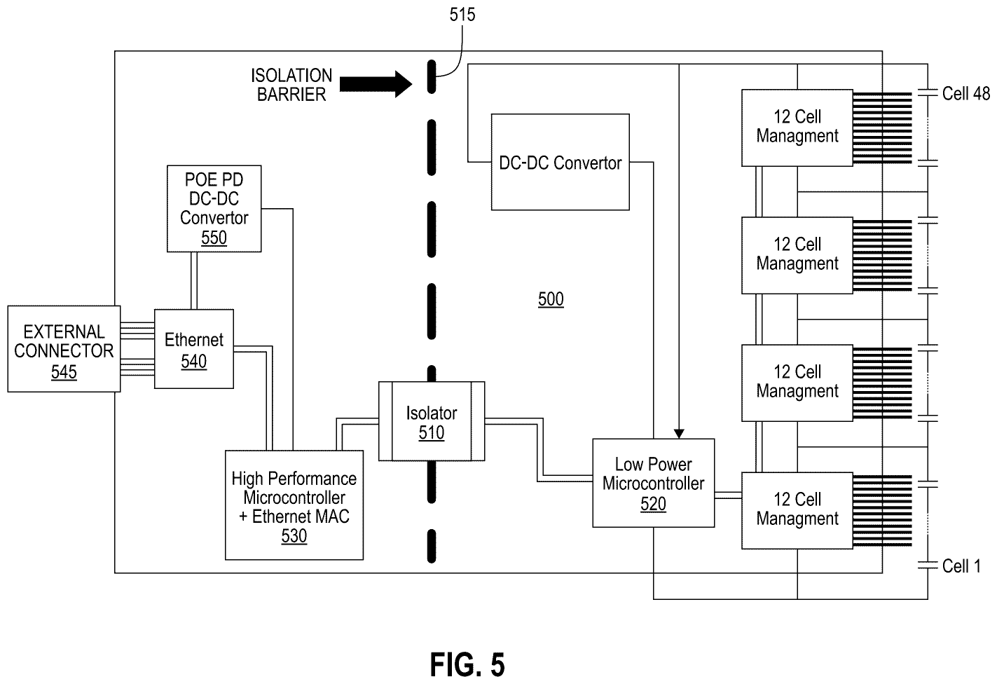

FIG. 5 is a layout of the controller 130 of the energy storage module 100 of FIGS. 1 through 3. The layout comprises a set of electrical components placed on a printed circuit board 500.

It can be seen that the module controller 130 first includes a Digital Isolator 510. This Digital Isolator 510 is designed to provide an isolated communications bridge. In one aspect, a 5 kV isolation barrier (depicted by dashed line 515) is created along the circuit board 500.

A module controller 520, 530 is provided on each side of the isolated communications bridge 515. Each module controller 520, 530 may be, for example, an ARM 32-bit micro-controller. A first micro-controller 520 is seen on the right side of the communications bridge 515. This may be a low-power micro-controller 520. This first micro-controller 520 is designed to manage cell monitoring and the balancing of the ultra-capacitors 110 in an associated energy storage module 100.

A second micro-controller 530 is seen on the left side of the isolation bridge 515. This is a high performance micro-controller 530 which includes a media-access controller (or MAC). The second micro-controller 530 interfaces with a cabinet controller (shown at 610 in FIG. 6) via a wired Ethernet. An Ethernet interface is indicated at 540. The Ethernet interface 540 is essentially a transceiver component for transmitting and receiving data, or so-called Ethernet frames. An external connection to the Ethernet interface is provided at 545.

The Ethernet interface 540 is connected to a Power-over-Ethernet Powered Device, indicated as a PoE PD 550. The PoE PD 550 receives electrical power from a connected Power Sourcing Equipment over existing copper Ethernet cables. The PoE PD 550 component includes a DC to DC converter. With a PoE Power Sourcing Equipment (PSE) switch, power and communications are assured with the second module controller 530 while the first module controller 520 is powered by the energy storage module 100. Note that the first module controller 520 only operates when the energy storage is at a high enough potential.

The circuit board 500 monitors the voltage of every individual cell 100. The circuit board 500 may also monitor the temperature of selected cells 100, such as every other energy storage cell 110. Voltage and temperature measurements are reported to the module controller 130. The module controller 130, in turn, communicates commands and data with cabinet controller 610 via Ethernet, and receives power via Power over Ethernet (POE) from the PoE PSE switch 940. A DC to DC converter associated with the module controller 520 is powered by syphoning power from the energy storage cells 110 being managed.

It is observed from the arrangement in FIGS. 1 through 3 that the module 100 does not include a housing. However, it is within the scope of this disclosure for a housing to be provided between the bulkheads 142, 144 in order to hold and to secure the plurality of energy storage cells 100 and the cooling tubes 120. In one aspect, the housing comprises an elongated sleeve having a contoured interior configured to enclose and contact each of the cooling tubes 120. The housing may include a mount configured to retain a circuit board to the elongated sleeve housing as well. An arrangement of a housing sleeve securing energy storage cells and a small controller is shown and described in connection with the '868 patent cited above and need not be shown or described further herein.

It is also observed that the module 100 as shown in FIGS. 1 through 3 is configured to be stackable. In this respect, five to twenty modules 100 may be stacked one on top of the other. Preferably, individual modules 100 are placed on rails or trays within a large cabinet, in a vertical arrangement. In this way, an energy storage assembly may be formed wherein a plurality of vertically-arranged energy storage modules 100 are electrically connected to each other in series via busbars 118.

In one aspect, a cabinet may have two stacks of modules, side-by-side. For example, two sets of up to 10 modules may reside within a single cabinet. Multiple cabinets may be placed in side-by-side arrangements. Each cabinet, with its corresponding energy storage modules 100, may be referred to as an energy storage assembly 400.

Each energy storage module 100 within a cabinet is in electrical connection with an adjacent energy storage module 100. Providing a plurality of modules, and a plurality of ultra-capacitors 110 arranged in series within the modules, allows an operator to pre-select a desired number of energy storage modules 100. This, in turn, allows for an assembly to have a predetermined operational value, including a predetermined voltage and/or capacitance. In addition, the lengths of energy storage modules 100 can be altered to provide discrete operational values for each module, and thus a different cumulative value for the assembly as a whole.

FIG. 4 is a perspective view of an energy storage assembly 400 of the present invention, in one embodiment. The energy storage assembly 400 comprises a plurality of individual energy storage modules 100, arranged in vertical stacks.

The energy storage assembly 400 first comprises at least one cabinet 410. It can be seen that in the arrangement of FIG. 4, two cabinets 410 are provided in adjacent relation. This shows that the assembly 400 is scalable. In this respect, numerous cabinets 410, each containing stacks of energy modules 100, may be provided and connected to a micro-grid.

Each of the illustrative cabinets 410 includes upper frame members 412, lower frame members 414, front frame members 416, and rear frame members 418. Each cabinet 400 is supported by feet 420, which may be in the form of rubber pads, casters, or other support members. In one aspect, the feet 420 are fabricated from ceramic to provide electrical insulation.

In one aspect, the feet 420 comprise a hardened polymeric material. The polymeric feet 420 have a serrated profile, allowing the feet 420 to absorb vibratory forces along the ground such as may be caused by a nearby motor or even a seismic event.

Each cabinet 410 further includes an upper support base (or top member) 432 and a lower support base (or bottom member) 434. The support bases 432, 434 provide lateral support for the frame members 412, 414, 416, 418. The support bases 432, 434 also provide gravitational support for equipment on the cabinets 400.

Of importance, each cabinet 410 includes racks 430, which may be in the form of rails. The racks 430 are in pairs, with each pair of racks 430 supporting a respective energy storage module 100. In the arrangement of FIG. 4, each cabinet 410 is configured to slidably hold 10 energy storage modules 100, meaning 10 sets of racks 430 are provided. Thus, the pair of cabinets 410 and their respective racks 430 hold a total of 20 modules 100.

Each module 100 can be slidably pulled or removed from its cabinet 410. In this way, maintenance can be conducted on components of the module 100, such as the replacement of any energy storage cell 110 that has shorted or burned out or replacing the module controller 130. In one aspect, each cabinet 410 is 8.2 feet (2.5 meters) in height, while each rack 430 is about 3.3 feet (1 meter) deep. Each module 100 may be about 2 feet (600 millimeters) wide.

It can be seen that busbars 118 connect not only terminals 112, 114 within an individual energy storage module 100, but also across adjacent energy storage modules 100. Stated another way, the busbars 118 provide electrical coupling between not only rows of energy storage modules 100, but also adjacent energy modules 100. The busbars 118 are connected to alternating positive 112 and negative 114 terminals In this way, all energy storage modules 100 are placed in series.

The cabinets 410 are also designed to be portable. In the arrangement of FIG. 4, the two cabinets 410 are secured together, with each cabinet having a fork lift sleeve 422. Each sleeve 422 includes an opening 425 for receiving a fork lift tine, thus serving as a lift point.

The energy storage assembly 400 includes an optional Auxiliary Power Source (APS). This is shown schematically at 460. The APS 460 may be, for example, a rechargeable battery pack or so-called electrical generator.

The energy storage assembly 400 also includes a pair of bypass switches 440. Each bypass switch 440 is supported by the upper support base 432. The bypass switches 440 are configured to bypass energy storage when a fault occurs.

In the arrangement of FIG. 4, two APS' are provided. Each APS is capable of powering the entire cabinet 410 for more than two hours via an uninterruptable power supply, e.g., chargeable battery packs. This means that a disruption in the grid will not immediately bring down power to the energy storage assembly 400. During operation, the onboard APS syphons power from the energy storage modules 100. The syphoned power is used in the event of a power outage or shutdown to power the controllers 520, 530 as well as the cooling system (described below).

FIG. 6 is a circuit diagram 600 that shows the general electrical connections between the energy storage modules 100. More specifically, FIG. 6 shows how all ultra-capacitor cells 100 are connected together within the cabinets 410.

Modules 1 through 10 are indicative of the energy storage modules 100 stored in a first cabinet 410. Similarly, Modules 11 through 20 are indicative of the energy storage modules 100 stored in a second cabinet 410. Modules 1 through 10 are connected with one another in series; likewise, Modules 11 through 20 are connected with one another in series. Of interest, Modules 1 through 10 are also connected with Modules 11 through 20 in series. Current flows from Module 1 to Module 10, and then into adjacent Module 11. Current then flows from Module 11 to Module 20, and then onto yet another adjacent module in another cabinet 410 (not shown).

In one aspect, a negative terminal of Module 10 may be connected to a positive terminal of Module 11. At the same time, the negative terminal of Module 10 and the positive terminal of Module 11 may both be tied to the chassis. This allows a cabinet 400 to, for example, provide 960 cells (480 cells in Modules 1 through 10 and 480 cells in Modules 11 through 20) in series with each other without exceeding 1,500 volts between any two components in a cabinet 410. Those of ordinary skill in the art will understand that 1,500 volts is sometimes considered to be a threshold for a low-voltage system.

A cabinet controller 610 is provided with the circuit 600. The cabinet controller 610 operates switches 612, 614. The switches 612, 614, in turn, control the amount of energy stored in the Modules by activating discharge resistors 621, 623. Data is fed from the module controllers 130 to the cabinet controller 610. The cabinet controller 610 is capable of activating bypass switches 440 for any stack of modules 100 to turn off, or bypass, current. In this way, operation of an energy storage assembly comprising a pair of cabinets 410 can continue even if any modules 100 in an individual cabinet 410 experiences a problem or fault.

To facilitate a bypass of current, electro-mechanical switches 622, 624 are employed. The electro-mechanical switches 622, 624 may be in the form of, for example, a magnetic low-voltage switch (“MLV”), an electro-mechanical relay, or a silicon controlled rectifier (“SCR”). In FIG. 6, the switches 622, 624 are shown below the stacked modules 100.

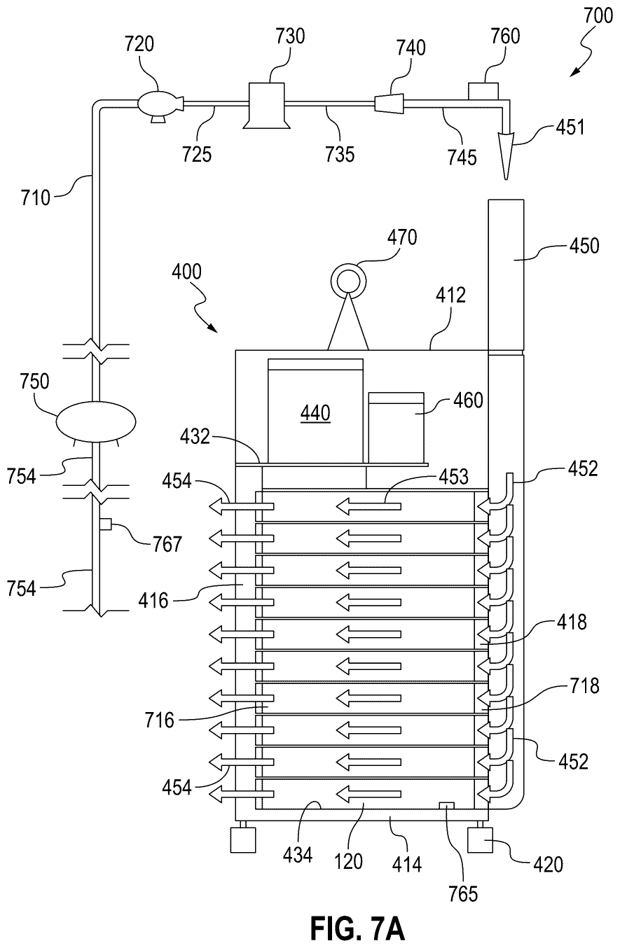

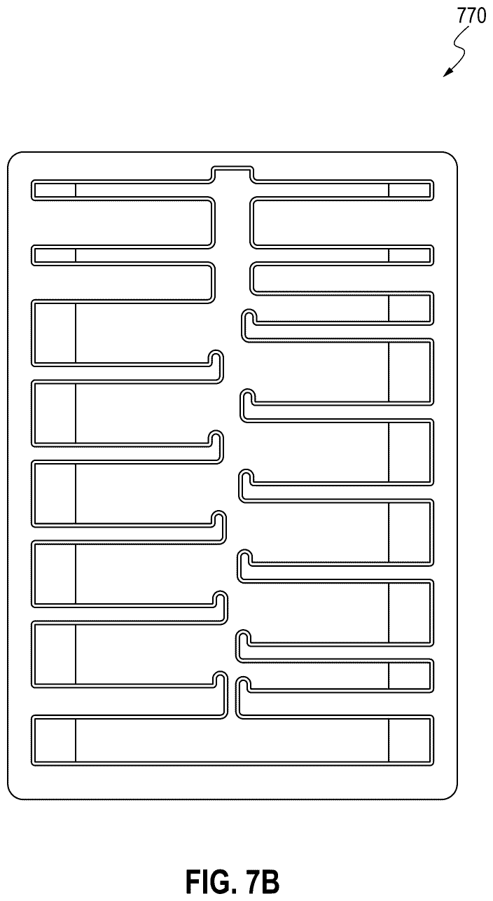

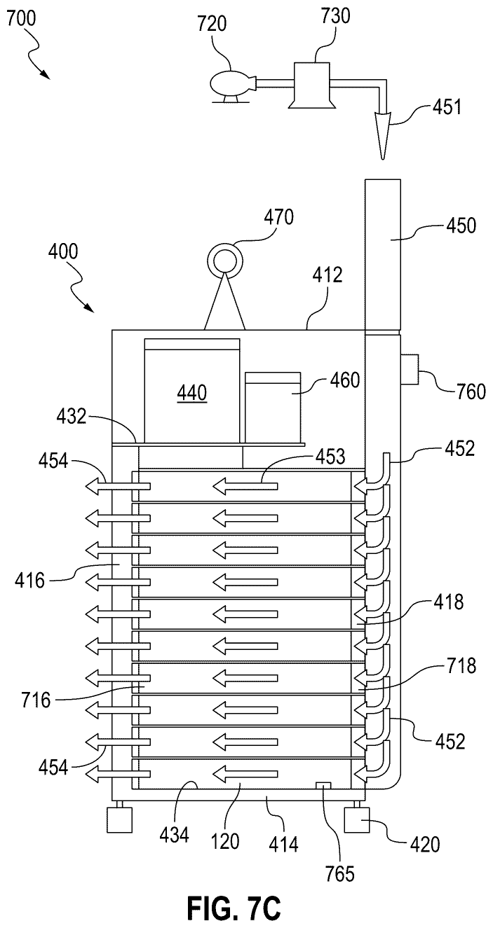

The modules 100 and their cabinets 410 are designed to be placed in electrical connection with a power grid. The power grid may be, for example, a privately owned power station, a dedicated industrial power station, a power station managed by a utility company, or a municipal power exchange. Note that the energy storage assembly 400 includes a high frequency current transformer (shown as 470 in FIG. 7A).

Returning back to FIG. 4, the energy storage assembly 400 finally includes a cooling system. A portion of the cooling system is seen in FIG. 4. Specifically, air coolant ducts 450 are observed.

FIG. 7A is a side view of the energy storage assembly of FIG. 4. This is a somewhat schematic view designed to demonstrate the movement of cooling fluid through the individual modules 100. To facilitate this movement and to provide cooling, cooling system 700 is shown.

The cooling system 700 first includes a working fluid line 710. The working fluid line 710 receives working fluid from a pressure vessel 750. The pressure vessel 750 holds a compressible fluid used as the working fluid. Examples of a working fluid that may be used include nitrogen, helium, argon, ammonia, carbon dioxide, and any known chlorofluorocarbons (CFCs) or hydro-chlorofluorocarbons (HCFCs).

The working fluid is transported through the working fluid line 710, under pressure, to a small gas compressor 720. The gas compressor 720 may pressurize the working fluid up to, for example, 75 to 200 psi. Note that the gas coolant is to be moved through potentially hundreds or even thousands of cooling tubes 120. Therefore, initial pressurization (or re-pressurization) is desirable.

Pressurized gas is pushed through line 725. The pressurized gas is optionally taken through a chiller 730. In this respect, it is observed that pressurizing the working fluid will increase its temperature. The chiller 730 may simply be a set of coils and fins, with an air blower pushing air across the coils and fins in order to lower the temperature of the pressurized gas. Alternatively, the chiller 730 may be a small liquid chiller where the pressurized gas is carried through a cold liquid, e.g., a cooled water or glycol container, via coils. In this instance, the chiller 730 is a true heat-exchanger.

In one example, a water-cooled chiller 730 pulls water into an evaporator. The evaporator transfers heat from the water to a refrigerant, chilling the water before sending it into a water tank. Coils carrying the pressurized gas are wound through the water tank to cool (or re-cool) the pressurized gas. Alternatively still, the chiller 730 may be a refrigeration unit where the pressurized gas is moved through a cooled air environment via coils. It is understood that the cooling system 700 is not to be limited by the type of chiller 730 employed.

The chilled, pressurized gas exits the chiller 730 through working fluid line 735. From there, the working fluid is pushed through an expander valve 740. This will further drop the temperature of the gas coolant. The amount of pressure drop effectuated across the expander valve 740 will determine the decrease in temperature.

From the expander valve 740, the chilled working fluid moves through coolant line 745 and into the air coolant ducts 450. This is shown by arrow 451. The working fluid enters the cooling tubes 120 at in-take ends 718 in accordance with arrows 452. Chilled working fluid passes along the rows 105 of individual ultra-capacitors 110A, 110B, 110C, . . . 110F. Specifically, chilled working fluid flows through the annular spaces 125 along the ID of the cooling tubes 120 as shown by Arrows 453. The coolant then exits the cooling tubes 120 at outlet ends 716 in accordance with arrows 454.

The horizontal arrangement of the cooling tubes 120 reduces the number of cells 110 each unit of cooling working fluid needs to cool. This, in turn, reduces the slope of the cell temperature gradient along the airflow path. For example, one unit of air passing horizontally needs to cool six cells 110 while the same unit of air passing vertically would need to cool 10 cells 110. It is observed that by reducing the number of energy cells 110 in a row 105 from 8 down to 6, the temperature differential (the “ΔT”) across the horizontal length of the rows 105 will be reduced as there will be fewer cells 110 to cool along each cooling tube 120.

Once the cooling working fluid exits the outlet ends 716, it merges into a return working fluid line 754. From there, the working fluid re-enters the pressure vessel 750. The pressure vessel 750 serves as a gas storage tank. The pressure vessel 750 will have suitable control valves as well as a pressure gauge (not shown). Ironically, the pressure vessel 750 serves the same general purpose for the cooling system 700 as the energy storage assembly 400 does for a power generation system. The pressure vessel 750 holds and modulates gas pressure while the energy storage assembly 400 holds and modulates electrical power.

In one aspect, the cooling system 700 further comprises a temperature sensor 760. The temperature sensor 760 may reside along the chilled working fluid lines 735 or 745. The temperature sensor 760 may be a thermistor-type device. The temperature sensor 760 is in electrical communication with or comprises a thermal controller. In response to readings from the temperature sensor 760, the thermal controller may send signals to (i) adjust a position of the expander nozzle 740, (ii) adjust a degree of cooling in the chiller 730, or (iii) both.

In another aspect, temperature sensors also reside along each of the cooling tubes 120, and/or along the rows 105 of the individual ultra-capacitors 110A, 110B, 110C, . . . 110H. In the schematic arrangement of FIG. 7, a single illustrative temperature sensor 765 is shown along a cooling tube 120. However, it is understood that additional temperature sensors 765 may be deployed.

A thermal sensor 767 may also be provided along the return working fluid line 754. The temperature sensor 760 (or “thermal controller”) may receive data from all of these other temperature sensors 765, 767 and determine whether to increase or decrease temperature in the chiller 730 and/or adjust the state or position of the expander valve 740. Alternatively or in addition, the thermal controller may send signals to valves (not shown) placed along the in-take ends 718 of each row 105 of capacitor cells 110 to increase or decrease the amount of gas coolant passing across the individual ultra-capacitors 110A, 110B, 110C, . . . 110H. Selected valves residing at the fluid in-take ends 718 may be opened or closed to meet a desired temperature (or a desired temperature range) within the respective cooling tubes 120. This allows the thermal controller 760 to control a degree or an amount of gas coolant that moves into selected groups of the cooling tubes 120.

In one embodiment, the flow of cooling working fluid may be controlled through an integral, injection-molded device called a plenum. FIG. 7B provides a side view of a plenum 770.

The plenum 770 is configured to receive the working fluid from the coolant ducts 450, and then deliver the working fluid into the inlet ends 418 of the cooling tubes 125. This is in accordance with arrows 452. The flow of working fluid, e.g., cooled air, along arrows 452 may be controlled by a plurality of valves residing along the plenum 770. This allows the plenum 770 to distribute air evenly between and among all of tubes 120. In one aspect, the plenum 770 employs tuned lengths and widths of air paths, as well as perforations that are tuned to provide necessary air path restriction to provide equal pressure and therefore flowrate to each cooling tube 120 within an energy storage assembly 400.

In another aspect of an energy storage assembly 400, a plurality of energy storage devices 100 may themselves be placed in side-by-side relation, forming an assembly of horizontally-placed modules. These horizontally placed modules may then, optionally, be stacked to form a larger energy storage assembly. In any event, it can be seen that the assembly 400 is scalable to meet operational demand.

Beneficially, the modular design of the energy storage assembly 400 allows adjustment for accommodating energy storage modules 100 of different sizes and numbers. Further, use of the cooling system 700 allows the working fluid to be manifolded into any number of air coolant ducts 450. If the number of cabinets 410 and the corresponding number of air coolant ducts 450 and cooling tubes 120 increases, additional volumes of gas coolant can be injected into the pressure vessel 750. The compressor 720 may optionally be adjusted to output working fluid at a higher pressure to accommodate the increased number of cooling tubes 120.

The illustrative cooling system 700 utilizes a single air compressor 720, a single chiller 730, and a single expansion valve 740. However, the cooling system 700 may be scaled up as needed to meet the cooling needs of multiple cabinets 410. Thus, the cooling system 700 of FIG. 7 is merely illustrative.

As noted, the cooling system 700 of FIG. 7 operates as a closed-loop cooling system. As an alternative, the cooling system 700 may be an open-loop cooling system. An open-loop cooling system is shown in FIG. 7C. In this arrangement, a fan or an air compressor may simply blow ambient air into the coolant ducts 450, forcing air through the annular spaces 125 of the cooling tubes 120. In this embodiment, the cooling system 700 comprises a gas compressor 720 and a chiller 730. The chilled working fluid moves through a coolant line, such as coolant line 745, and into the air coolant ducts 450. This is shown by arrow 451. The working fluid then enters the cooling tubes 120 at in-take ends 718 in accordance with arrows 452. Air (or, optionally, a chilled working fluid) passes along the rows 105 of individual ultra-capacitors 110A, 110B, 110C . . . 110H. Specifically, working fluid flows through the annular spaces 125 along the ID of the cooling tubes 120. The coolant exits the cooling tubes 120 at outlet ends 716 in accordance with arrows 454.

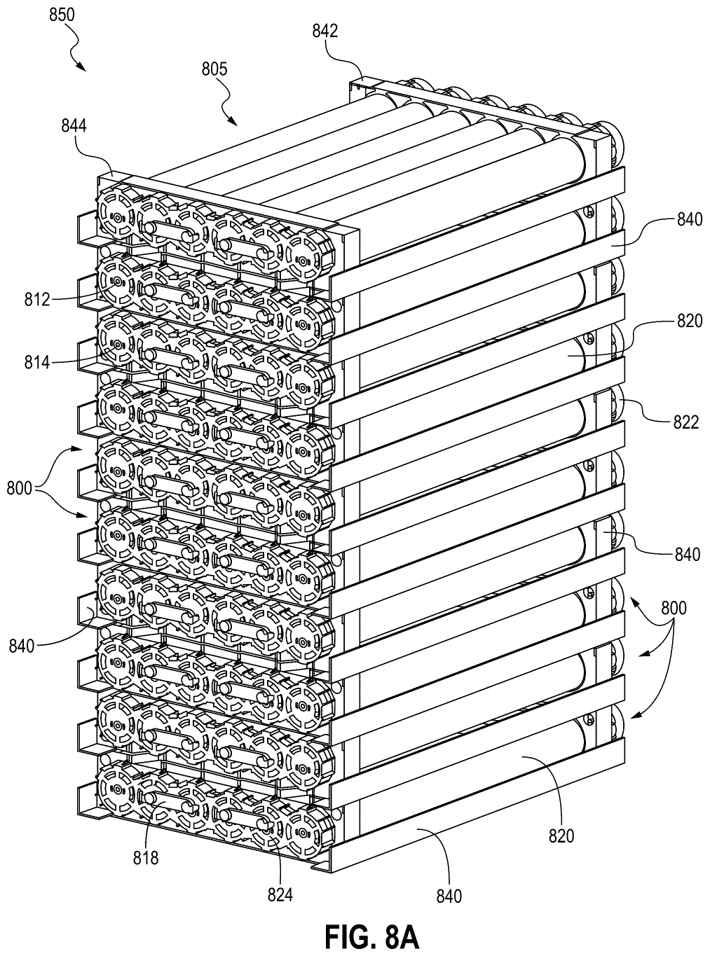

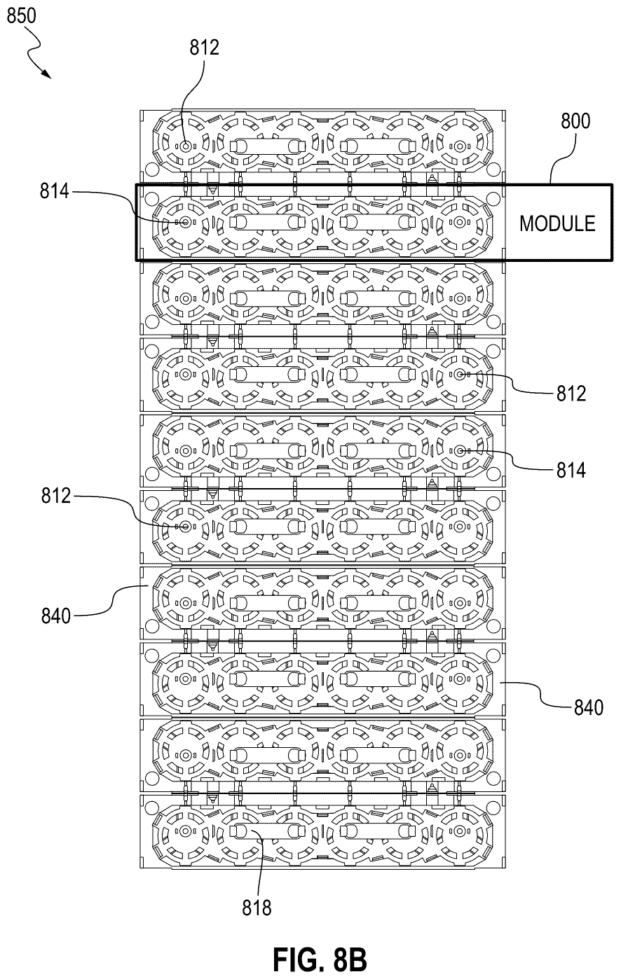

FIG. 8A is a perspective view of a plurality (or stack) 850 of energy storage modules 800, placed one on top of the other, in an alternate embodiment. The stack 850 represents a portion of an energy storage assembly. Each energy storage module 800 comprises an array of ultra-capacitors 810.

FIG. 8B is an end view of the stack 850 of energy storage modules 800 of FIG. 8A. As shown, the stack 850 represents ten energy storage modules 800 stacked one on top of the other.

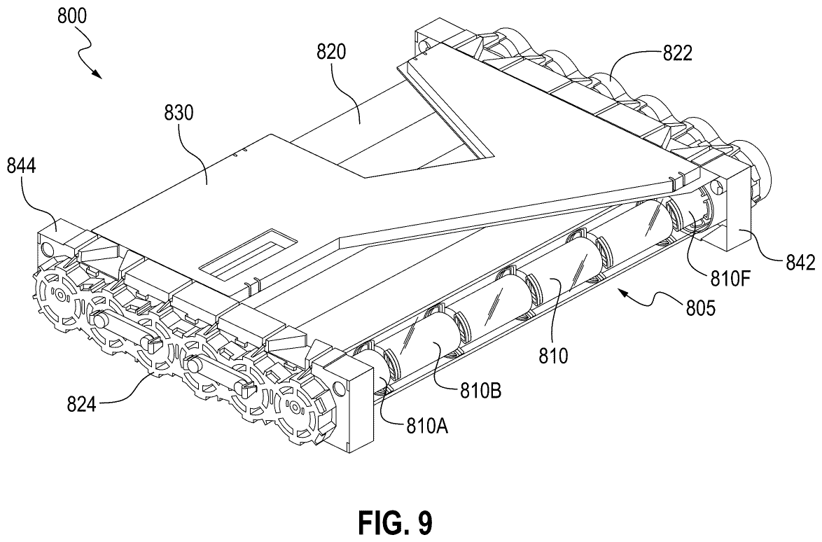

FIG. 9 is a perspective view of one of the energy storage modules 800 of FIG. 8B. In this view, one of the cooling tubes 820 has been removed, revealing individual ultra-capacitor cells 810A, 810B, . . . 810F.

The energy storage modules 800 will be described with reference to FIGS. 8A, 8B, and 8C, together.

Each energy storage module 800 is supported by a pair of bulkheads, or end plates. These are indicated as a first bulkhead 842 and a second bulkhead 844. The bulkheads 842, 844 comprise a plurality of equi-distantly spaced through-openings (not visible, but see apertures 145 in FIGS. 1 and 3). The through-openings are dimensioned to closely receive tubular coolant tubes 820.

As with the energy storage modules 100, each of the energy storage modules 800 holds rows 805 of energy storage cells 810. In the illustrative arrangement, 6 energy storage cells 810A, 810B, . . . 810F are placed in series. At the same time, 6 rows of energy storage cells 810 are provided in side-by-side relation. Thus, a six-by-six array of cells 810 is presented. With ten energy storage modules 800 stacked one on top of the other, a total of 360 energy storage cells 810A-810F are provided.

The rows 805 of energy storage cells 810 have alternating positive (or input) 812 and negative (or output) 814 terminals. Electrical energy is transmitted from the positive terminal 812, into energy storage cell 810A of each row 805, on to energy storage cell 810F of each row 805, and to negative terminal 814. All energy storage cells 810 are connected and arranged in series, meaning that the negative terminal 814 of one row 805 is in electrical communication with the positive terminal 812 of an adjacent row 805.

In the arrangement of FIGS. 8A, 8B, and 8C, the opposing ends of the rows 805 of ultra-capacitor cells 810A-810F are covered by an end cap. End caps 822 reside outside of bulkhead 842, while end caps 824 reside outside of bulkhead 844. The end caps 822, 824 are fabricated from a non-conductive polymeric material. Of interest, each end cap comprises six small through-openings that accommodate terminals. Thus, the openings in the bulkheads 822, 824 accommodate terminals 812, 814.

The terminals 812, 814 are connected by conductive busbars (seen at 118 in FIGS. 1 and 3). Specifically, the busbars 118 may connect the adjacent output 814 and input 812 terminals. The busbars 118 may reside either inside of or outside of the respective end caps 822, 824, so long as the busbars 118 are in physical connection with the appropriate terminals 812 and 814.

The busbars 118 are not visible in FIG. 8A, 8B, or 8C as they are covered by specially-configured busbar covers 818. The busbar covers 818 prevent accidental contact with electrical connections. Holes in the end caps 822, 824 are configured to minimize possibility of accidental contact with electrical connections inside the cooling tubes 820.

The end caps 822, 824 provide axial restraint to the energy storage cells 810A-810F. Each end cap 822, 824 comprises holes that allow cooling air to pass through the associated tubes 820. One of the end caps 822 or 824 interfaces with a coolant duct, such as coolant duct 450, as described above.

Each module 800 is supported by shelving, or rails 840. The rails 840 support the bulkheads 842, 844, which in turn support the cooling tubes 820. Stated another way, the bulkheads 842, 844 provide side-to-side support for the module 800.

As seen in FIG. 8C, a plurality of ultra-capacitors 810A, 810B, . . . 810F reside within the cooling tubes 820. Preferably, ultra-capacitors 810A, 810B, . . . 810F along a row 805 are oriented in an end-to-end configuration. The energy storage cells 810 may be welded together end-to-end. Optionally, the spacers 125 of FIG. 3 may be used to centralize the energy storage cells 810 within the cooling tubes 820. Alternatively, an inner diameter of each cooling tube 820 may be manufactured with integral fins that centralize the cooling tubes 820. Both embodiments facilitate the flow of a cooling working fluid. Positive 812 and negative 814 terminals reside at opposite ends of the energy storage cells 810.

Finally, the energy storage module 801 comprises a module controller 830. The controller 830 monitors the rows 805 of energy storage cells 810. Preferably, the controller 830 is configured to provide cell balancing within rows 805. The controller 830 may also monitor conditions within or along each module 800 such as temperature.

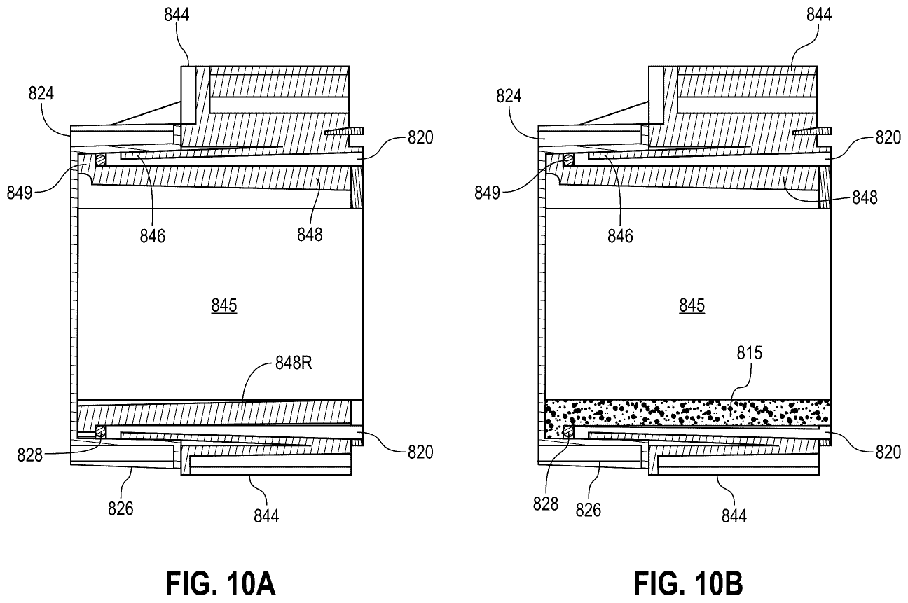

FIG. 10A is a first side view of an end of the module 800 of FIG. 9. The side view is taken through an end plate, such as end plate 844. The end plate 844 serves as a bulkhead, holding the cooling tube 820 in place. A central opening 845 of the end cap 844 is visible, receiving an end of the cooling tube 820.

The end plate 844 includes an optional fishtrap snap (or snap feature) 846. The snap feature 846 slides under the end cap 824. Specifically, the snap feature 846 slides into an inwardly-facing shoulder 826 of the end cap 824.

The end plate 844 includes an inner diameter portion 848. The inner diameter portion 848 forms an annular recess that closely receives the cooling tube 820. The inner diameter has a lip 849 that abuts against an inner surface of the end cap 824. Of interest, a gasket 828 resides along the lip 849. The gasket 828 provides a fluid seal between and among the lip 849, the shoulder 826 of the end cap 824, and the inner diameter portion 848 of the end plate 844.

Within the inner diameter portion 848 is a lower reservoir 848R. The lower reservoir 848R is configured to receive liquids that leak from the energy storage cells 810. Those of ordinary skill in the art will understand that battery cells may leak acid, and ultra-capacitor cells may leak electrolytic fluids. The lower reservoir 848R is designed to contain those fluids to prevent leakage and gravitational dripping into lower modules 800.

FIG. 10B is a second side view of the end of the module 800 of FIG. 9. In this view, electrolyte 815 has been captured in the reservoir 848R of the module 800. Ideally, the lip 849 is high enough to retain as much electrolyte 815 as could feasibly be released from the cells 810. Containment prevents the liquid electrolyte 815 from making contact with nearby modules 800 or other equipment, e.g., components of cabinet 410.

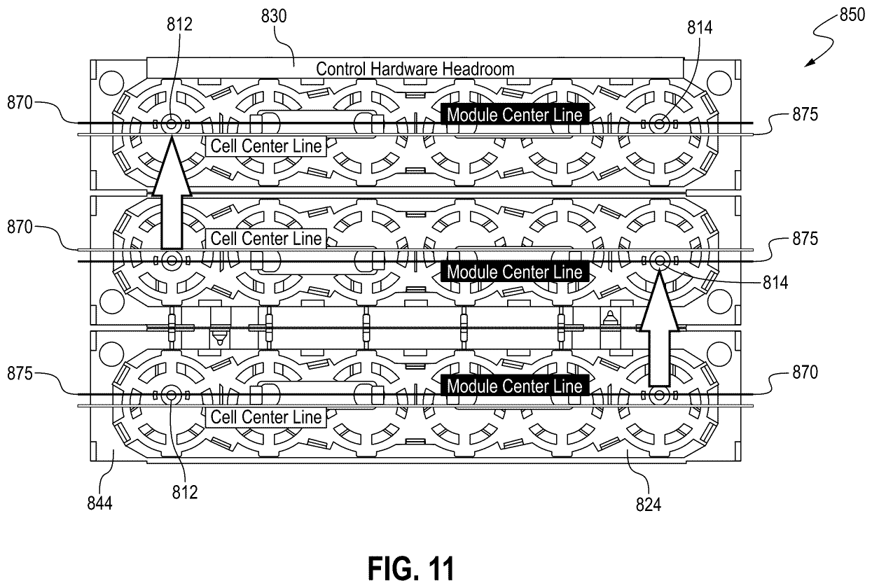

FIG. 11 is an enlarged end view of the stack of energy storage modules 800 of FIG. 8. Three modules 800, representing three end caps 824 and three bulkheads 844, are visible, stacked one on top of the other. In this view, it is observed that the bulkheads 844 are configured such that the cooling tubes 820 are “offset” from a horizontal center plane of the modules 800. This allows for space above the cooling tubes 820 for control electronics 830.

In FIG. 11, a first line 870 is shown, representing a horizontal center line. A second line 875 is shown representing a module center line. It can be seen that lines 870 and 875 are offset from each other. The bolted terminal connections are equally offset in an opposite direction such that adjacent modules 800 are equi-distant from each other. This allows the modules 800 to be flipped without requiring multiple busbars 118 to connect adjacent modules 800. Being able to flip the modules 800 further allows the positive 112 and negative 114 terminals of adjacent modules 800 to be beside each other but built with identical parts and process.

As can be seen, a new energy storage assembly (e.g., assembly 400) is provided. The assembly utilizes a plurality of energy storage modules 100, 800 uniquely designed to hold multiple ultra-capacitor cells 110, 810 in a secure manner. For example, the use of elastomeric spacers 125 along with elastomeric end plates 142, 144, 842, 844 provides flexibility, allowing a cabinet 410 of energy storage modules 100, 800 to withstand a seismic event. The use of the spacers 125 further facilitates uniform cooling along the surfaces of each cell 110, 810.

The use of a closed-loop cooling system is beneficial for high-power applications where energy storage modules having a large array of capacitor cells are employed. In one aspect, ten cabinets 410 are employed, with each cabinet 410 having ten racks 430, and with each rack 430 having 36 energy cells. This creates a micro-grid with 7,200 energy cells, placed in series. In another aspect, ten cabinets 410 are employed, with each cabinet 410 having twenty racks 430, and with each rack 430 having 48 energy cells. This creates a micro-grid with 9,600 energy cells, placed in series.

The cabinets 410 of energy storage modules are particularly beneficial when used as part of a FAST system, that is, a fast frequency response that allows for rapid adjustments to electricity supply and demand imbalances to maintain grid stability. In this case, for example, if a grid has too much power, the energy storage cells 110 or 810 can absorb the power. On the other hand, if the grid needs power, then energy stored in the energy storage cells 110 or 810 can provide the power. Thus, a series of cabinets with their cabinet controllers may serve as a sink and as a source for active power in a FACTS system.

Each cabinet 410 may have a first electrical terminal (e.g., positive side) and a second electrical terminal (e.g., negative side). The operator may run into either the positive side or the negative side, so long as the busbars 118 are arranged appropriately to feed current through the modules, in series. The series of cabinets is designed to be flexible and can be sized to provide whatever continuous power requirement a transmission system operator may specify.

In addition, the design of the energy storage modules 800 provides for the capture of liquid electrolyte that may leak from cells 810 during operation. This encourages the evaporation and rapid evacuation of electrolyte vapor from the structure. Beneficially, forced air passing through the cooling tubes 120, 820 will encourage electrolyte evaporation, and will immediately evacuate the vaporized electrolyte from the larger support structure.

In the claims which follow, the word “comprising” is used in its inclusive sense and does not exclude other elements being present. The indefinite articles “a” and “an” before a claim feature do not exclude more than one of the feature being present. Each one of the individual features described here may be used in one or more embodiments and is not, by virtue only of being described here, to be construed as essential to all embodiments as defined by the claims.

We claim:

1. An energy storage assembly for storing electrical energy, the energy storage assembly comprising:
a cabinet;
a first electrical terminal for receiving electrical energy into the cabinet;
a second electrical terminal for delivering electrical energy out of the cabinet;
a plurality of energy storage modules stacked in vertical arrangement along the cabinet, wherein each energy storage module comprises:
two or more rows of energy storage cells, with the energy storage cells being connected electrically in series, and wherein each row of energy storage cells has its own positive terminal and negative terminal; and
a plurality of cooling tubes, wherein each cooling tube comprises a tubular body having an inlet end, an outlet end opposite the inlet end, and an inner diameter, with each cooling tube receiving a respective row of energy storage cells end-to-end;
and wherein:
the rows of energy storage cells within each energy storage module reside electrically in series; and
the energy storage modules reside electrically in series between the first electrical terminal of the energy storage assembly and the second electrical terminal of the energy storage assembly.

2. The energy storage assembly of claim 1, wherein the energy storage cells comprise batteries, capacitors, or a combination thereof.

3. The energy storage assembly of claim 2, further comprising:
a plurality of busbars, wherein:
each of a first portion of the busbars connects the negative terminal of a first energy storage module with the positive terminal of an adjacent second energy storage module; and
each of a second portion of the busbars connects the negative terminal of a first row of energy storage cells to the positive terminal of an adjacent second row of energy storage cells.

4. The energy storage assembly of claim 3, wherein:
the plurality of energy storage modules comprises at least four energy storage modules stacked one on top of the other.

5. The energy storage assembly of claim 4, wherein:
each of the plurality of energy storage modules resides on a rack, a shelf, or a rail within the cabinet;
the negative terminal of each row of capacitor cells is in electrical connection with a positive terminal of an adjacent row of capacitor cells such that the rows of capacitor cells are in series.

6. The energy storage assembly of claim 5, wherein:
each row of energy storage cells comprises at least four capacitor cells positioned end-to-end.

7. The energy storage assembly of claim 6, wherein:
each energy storage cell is an ultra-capacitor cell.

8. The energy storage assembly of claim 5, further comprising:
at least one temperature sensor associated with each energy storage module;
a bypass switch associated with one or more energy storage modules; and
a module controller associated with each energy storage module, wherein each module controller is configured to (i) receive data related to voltage across each energy storage module, and (ii) receive data from the at least one temperature sensor.

9. The energy storage assembly of claim 8, further comprising:
a cabinet controller configured to receive data from each of the module controllers and, in response, control the bypass switches associated with the energy storage modules.

10. The energy storage assembly of claim 9, wherein:
each energy storage module comprises at least six rows of capacitor cells; and
each row of capacitor cells within each energy storage module comprises at least six capacitor cells positioned end-to-end.

11. The energy storage assembly of claim 9, further comprising:
a plurality of spacers residing around or between selected energy storage cells within each cooling tube, wherein the spacers form an annular space between a row of energy storage cells and the corresponding cooling tube; and
a plenum configured to receive chilled gas coolant, and deliver the chilled gas coolant into the inlet end of each of the respective cooling tubes under pressure, such that the chilled gas coolant moves horizontally through the annular space of each cooling tube and out of the outlet end.

12. The energy storage assembly of claim 11, further comprising:
a valve associated with the inlet end of each row of the energy storage cells;
and wherein the cabinet controller is in electrical communication with each of the valves, and is configured to sends signals to adjust a position of the respective valves to control a degree of cooling across the energy storage cells.

13. The energy storage assembly of claim 2, wherein the cabinet is in electrical connection with a power station or a micro-grid.

14. An energy storage assembly for storing electrical energy, the energy storage assembly comprising:
a plurality of cabinets, wherein each cabinet comprises:
a first electrical terminal for receiving electrical energy into the cabinet;
a second electrical terminal for delivering electrical energy from the cabinet; and
a plurality of energy storage modules stacked in vertical arrangement along the cabinet, and wherein each energy storage module comprises:
two or more rows of energy storage cells, with the energy storage cells being connected electrically in series, and wherein each row of energy storage cells has its own positive terminal and negative terminal; and
a plurality of cooling tubes, wherein each cooling tube comprises a tubular body having an inlet end, an outlet end opposite the inlet end, and an inner diameter, with each cooling tube receiving a respective row of energy storage cells end-to-end;
and wherein:
the rows of energy storage cells within each energy storage module reside electrically in series;
the energy storage modules reside electrically in series between the positive terminal and the negative terminal of its respective cabinet; and
each of the plurality of cabinets resides electrically in series.

15. The energy storage assembly of claim 14, wherein the energy storage cells comprise batteries, capacitors, or a combination thereof.

16. The energy storage assembly of claim 15, further comprising:
a plurality of busbars, wherein:
each of a first portion of the busbars connects the negative terminal of a first energy storage module with the positive terminal of an adjacent second energy storage module; and
each of a second portion of the busbars connects the negative terminal of a first row of energy storage cells to the positive terminal of an adjacent second row of energy storage cells.

17. The energy storage assembly of claim 16, wherein:
the plurality of energy storage modules comprises at least four energy storage modules stacked one on top of the other within each cabinet.

18. The energy storage assembly of claim 17, wherein:
each of the plurality of energy storage modules resides on a rack, a shelf, or a rail within a cabinet;
the negative terminal of each row of capacitor cells is in electrical connection with a positive terminal of an adjacent row of capacitor cells such that the rows of capacitor cells are in series.

19. The energy storage assembly of claim 18, wherein:
each row of energy storage cells comprises at least four capacitor cells positioned end-to-end.

20. The energy storage assembly of claim 18, further comprising:
at least one temperature sensor associated with each energy storage module;
a bypass switch associated with each one or more energy storage modules; and
a module controller associated with each energy storage module, wherein each module controller is configured to (i) receive data related to voltage across each energy storage module, and (ii) receive data from the at least one temperature sensor.

21. The energy storage assembly of claim 20, wherein:
each cabinet further comprises a controller configured to (i) receive data from each of the module controllers in its respective cabinet and, in response, (ii) control the bypass switches associated with the energy storage modules in its respective cabinet.

22. The energy storage assembly of claim 21, wherein:
each energy storage module comprises at least six rows of capacitor cells; and
each row of capacitor cells within each energy storage module comprises at least six capacitor cells positioned end-to-end.

23. The energy storage assembly of claim 22, wherein:
a plurality of spacers residing around or between selected energy storage cells within each cooling tube, wherein the spacers form an annular space between a row of energy storage cells and the corresponding cooling tube; and
each cabinet further comprises a plenum configured to receive chilled gas coolant, and deliver the chilled gas coolant into the inlet end of each of the respective cooling tubes within its respective cabinet under pressure, such that the chilled gas coolant moves horizontally through the annular space of each cooling tube and out of the respective outlet ends.

24. The energy storage assembly of claim 23, wherein:
each cabinet further comprises a valve associated with the inlet end of each row of the energy storage cells; and
the cabinet controller for each cabinet is in electrical communication with each of the valves of the respective cabinet, and is configured to sends signals to adjust a position of the respective valves to control a degree of cooling across the energy storage cells.

25. The energy storage assembly of claim 15, wherein the cabinets are in electrical connection with a power station or a micro-grid.
